(19) United States
(12) Patent Application Publication
(10) Pub. No.: US 2017/0373326 A1
(43) Pub. Date: Dec. 28, 2017

(54) THERMOELECTRIC DEVICE

(71) Applicant: NATIONAL TAIWAN OCEAN UNIVERSITY, Keelung (TW)

(72) Inventors: JUNG-CHANG WANG, Keelung (TW); JUNG-CHU WANG, Keelung (TW); YEN-CHUN CHEN, Keelung (TW)

(21) Appl. No.: 15/626,400

(22) Filed: Jun. 19, 2017

(30) Foreign Application Priority Data
Jun. 24, 2016 (TW) 105119881

(51) Int. Cl. H01M 6/36; H01M 4/46; H01M 4/583

(52) U.S. Cl. CPC H01M 6/36; H01M 4/583; H01M 4/463; H01M 2300/0002

(57) ABSTRACT

A thermoelectric device includes a tubular electrode filled with an electrolyte, a core rod electrode inserted in the tubular electrode and in contact with the electrolyte, and at least one plug configured to separate the tubular electrode from the core rod electrode and to cover a filling opening of the tubular electrode. The plug is located between the tubular electrode and the core rod electrode. When the tubular electrode and the core rod electrode have a temperature difference, thermal energy can be directly converted into electric energy by the redox reaction of the electrolyte, and the tubular electrode and the core rod electrode can generate electromotive force. In particular, the thermoelectric device may use the structural design between the tubular electrode and the core rod electrode to provide a greater contact area with a heat source, and may be directly immersed in a heat source.

### FIELD OF THE INVENTION

The present invention relates to a thermoelectric device, and more particularly to a thermoelectric device having better heat conduction performance and suitability.

### BACKGROUND OF THE INVENTION

A thermoelectric device is capable of generating electromotive force at a temperature difference to convert thermal energy into electric energy and vice versa. Therefore, it is particularly suitable for introducing this technology into industrial waste heat and automotive waste for recycling and reusing to reduce carbon dioxide emission. When the thermoelectric device generates a reverse reaction through the power to bring the heat from the cold end to the hot end to cause the so-called thermoelectric cooling effect which can be used for heat dissipation or as a small-sized freezer.

With the improvement of the characteristics of thermoelectric materials and the improvement of power generation performance of thermoelectric modules, many devices using thermoelectric elements have been developed, such as portable coolers for camping, small power generation furnaces for camping, mobile refrigerators used in vehicles, CPU heat sinks for computers, waste heat recovery systems, and so on.

In general, a conventional thermoelectric device includes several pairs of P-N thermoelectric elements arranged regularly between two alumina ceramic substrates. Cu metal electrodes are connected with the pairs of P-N thermoelectric elements by soldering to constitute an electrical series connection. However, the conventional thermoelectric elements are designed in the form of a thin plate or a sheet, so only a single plane to get contact with a heat source and the contact with the heat source is also subject to more restrictions, resulting in poor heat conduction and poor suitability. Accordingly, the inventor of the present invention has devoted himself based on his many years of practical experiences to solve these problems.

### SUMMARY OF THE INVENTION

The primary object of the present invention is to provide a thermoelectric device which has relatively better heat conduction performance and relatively suitability.

In order to achieve the aforesaid object, the thermoelectric device comprises a tubular electrode, a core rod electrode, and at least one plug. The tubular electrode is made of a conductive material and has a tubular shape with a predetermined space therein. One end of the tubular electrode is formed with a filling opening for filling an electrolyte. The core rod electrode is made of a conductive material and has a rod-like shape. The core rod electrode is inserted in the tubular electrode. The plug is configured to separate the tubular electrode from the core rod electrode and to cover the filling opening of the tubular electrode. The plug is located between the tubular electrode and the core rod electrode. The electrolyte in contact with the tubular electrode and the core rod electrode is sealed in the tubular electrode.

The thermoelectric device of the present invention generates an electrochemical reaction among the tubular electrode, the core rod electrode, and the electrolyte. When the tubular electrode and the core rod electrode have a temperature difference, thermal energy can be directly converted into electric energy by the redox reaction of the electrolyte, and the tubular electrode and the core rod electrode can generate electromotive force, which can be used for heat dissipation and is able to output additional electric energy. In particular, the thermoelectric device may use the structural design between the tubular electrode and the core rod electrode to provide a greater contact area with a heat source, and may be directly immersed in a heat source. The thermoelectric device has relatively better heat conduction performance and relatively suitability.

Preferably, a portion of the core rod electrode, extending out of the tubular electrode, is covered with an electrode cap made of a conductive material.

Alternatively, a portion of the core rod electrode, extending out of the tubular electrode, is sleeved with an insulating sleeve made of an insulating material. The insulating sleeve has an electrode receiving hole for exposing an end face of the core rod electrode.

Preferably, another portion of the core rod electrode, inserted into the tubular electrode, is sleeved with at least one support washer made of an insulating material.

Preferably, a portion of the core rod electrode, extending out of the tubular electrode, is covered with an electrode cap made of a conductive material, and another portion of the core rod electrode, inserted into the tubular electrode, is sleeved with at least one support washer made of an insulating material.

Preferably, a portion of the core rod electrode, extending out of the tubular electrode, is sleeved with an insulating sleeve made of an insulating material, the insulating sleeve has an electrode receiving hole for exposing an end face of the core rod electrode, and another portion of the core rod electrode, inserted into the tubular electrode, is sleeved with at least one support washer made of an insulating material.

Preferably, the electrolyte is a nanofluid mixed with a metal nanopowder.

Preferably, the electrolyte is a nanofluid mixed with a metal nanopowder and a surfactant.

Preferably, the electrolyte is a nanofluid mixed with a metal nanopowder selected from one of titanium oxide, zinc oxide and alumina.

Preferably, the electrolyte is a nanofluid mixed with a semiconductor nanopowder selected from one of lead telluride, bismuth telluride, cadmium telluride, and silicon germanium alloy.

Preferably, the electrolyte is a nanofluid mixed with a graphene nanopowder.

Preferably, the electrolyte is a nanofluid mixed with a metal nanopowder selected from one of titanium oxide, zinc oxide and alumina and a surfactant.

Preferably, the electrolyte is a nanofluid mixed with a semiconductor nanopowder selected from one of lead telluride, bismuth telluride, cadmium telluride, and silicon germanium alloy and a surfactant.

Preferably, the electrolyte is a nanofluid mixed with a graphene nanopowder and a surfactant.

Preferably, the electrolyte is pure water mixed with 2 wt % of titanium oxide, 2 wt % of emulsifier, and 2 wt % of dispersant.

Preferably, the tubular electrode is formed of aluminum or aluminum alloy.

Preferably, the core rod electrode is a carbon rod.

Preferably, the electrode cap is formed of copper or copper alloy.

Preferably, the insulating sleeve is formed of Teflon.

Preferably, the electrolyte is sealed inside the tubular electrode under a negative pressure environment.

Preferably, the support washer is integrally formed with the insulating sleeve.

Preferably, the support washer is provided with outer threads, and the tubular electrode is provided inner threads.

The thermoelectric device of the present invention may be used for heat dissipation and is able to output additional electric energy, and may use the structural design between the tubular electrode and the core rod electrode to provide a greater contact area with a heat source, and may be directly immersed in a heat source, so that it has relatively better heat conduction performance and relatively suitability. In particular, the overall structural design is beneficial for nanorizing a material used for redox, with a more positive and reliable means to enhance the thermal efficiency of the thermoelectric device.

### BRIEF DESCRIPTION OF THE DRAWINGS

FIG. 1 is a perspective view in accordance with a first embodiment of the present invention;

FIG. 2 is an exploded view in accordance with the first embodiment of the present invention;

FIG. 3 is a sectional view in accordance with the first embodiment of the present invention;

FIG. 4 is a sectional view in accordance with the first embodiment of the present invention in a use state;

FIG. 5 is a perspective view in accordance with a second embodiment of the present invention;

FIG. 6 is an exploded view in accordance with the second embodiment of the present invention; and

FIG. 7 is a sectional view in accordance with the second embodiment of the present invention.

### DETAILED DESCRIPTION OF THE PREFERRED EMBODIMENTS

Embodiments of the present invention will now be described, by way of example only, with reference to the accompanying drawings.

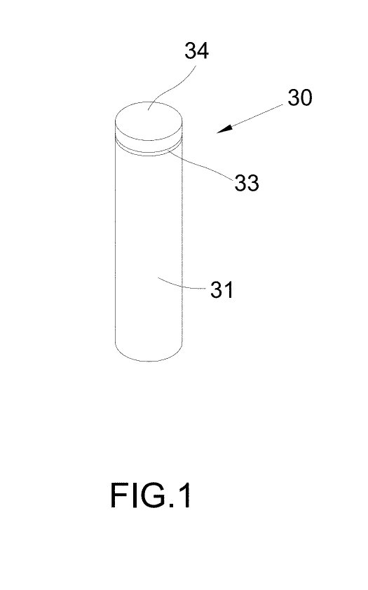

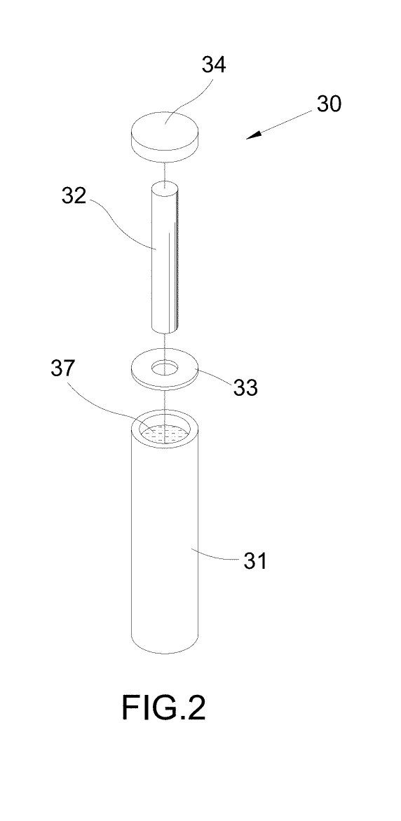

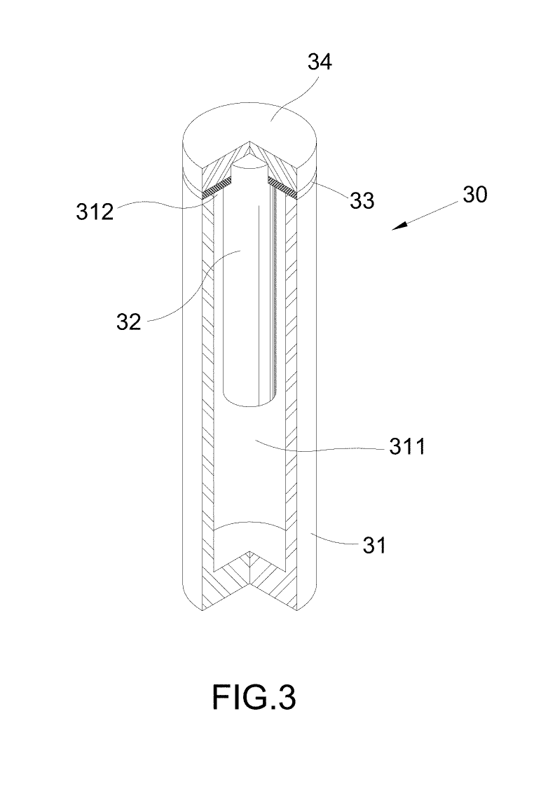

The present invention is to provide a thermoelectric device 30 which has relatively better heat conduction performance and relatively suitability. As shown in FIG. 1 to FIG. 4, the thermoelectric device 30 of the present invention comprises a tubular electrode 31, a core rod electrode 32, and at least one plug 33.

The tubular electrode 31 is made of a conductive material and has a tubular shape with a predetermined space 311 therein. One end of the tubular electrode 31 is formed with a filling opening 312 for filling an electrolyte 37. In an embodiment, the tubular electrode 31 is formed of aluminum or aluminum alloy.

The core rod electrode 32 is made of a conductive material and has a rod-like shape. The core rod electrode 32 is inserted in the tubular electrode 31. In an embodiment, the core rod electrode 32 may be a carbon rod.

The plug 33 is configured to separate the tubular electrode 31 from the core rod electrode 32 and to cover the filling opening 312 of the tubular electrode 31. The plug 33 is located between the tubular electrode 31 and the core rod electrode 32. The electrolyte 37 is in contact with the tubular electrode 31 and the core rod electrode 32 and sealed in the tubular electrode 31.

In principle, the thermoelectric device 30 of the present invention generates an electrochemical reaction among the tubular electrode 31, the core rod electrode 32, and the electrolyte 37. When the tubular electrode 31 and the core rod electrode 32 have a temperature difference, thermal energy can be directly converted into electric energy by the redox reaction of the electrolyte, and the tubular electrode 31 and the core rod electrode 32 can generate electromotive force, which can be used for heat dissipation and is able to output additional electric energy. The electric energy can be transmitted to an electrical apparatus 10 or a storage device. The discharged thermal energy is converted into electric energy for recycling and reusing.

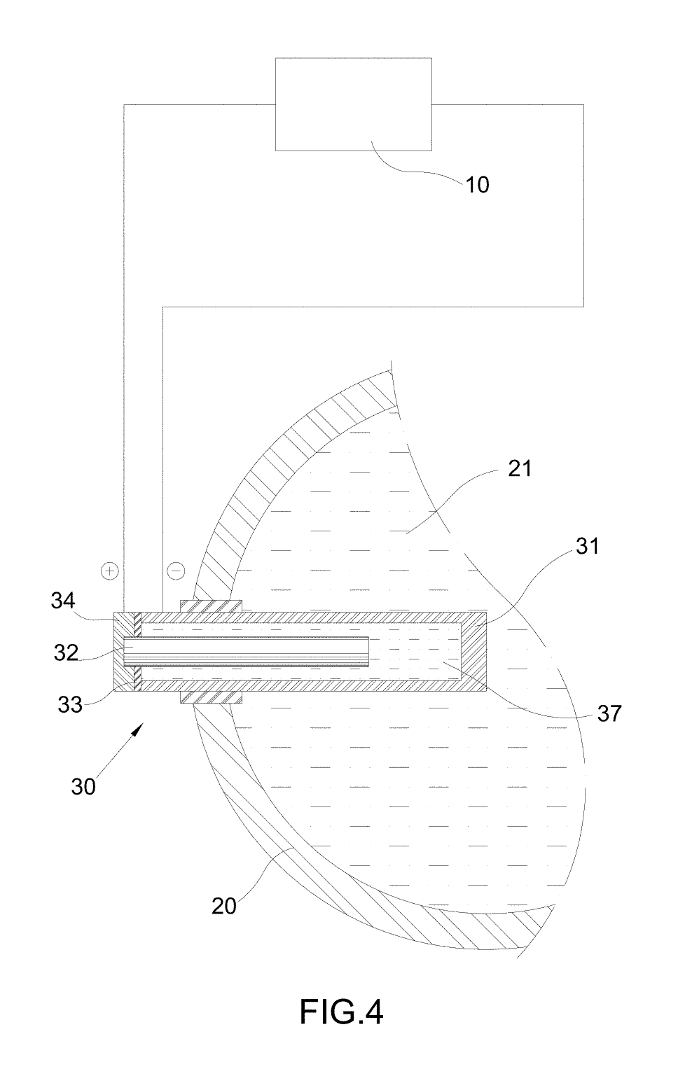

In particular, the thermoelectric device 30 may use the structural design between the tubular electrode 31 and the core rod electrode 32 to provide a greater contact area with a heat source, and may be directly immersed in a heat source. For example, as shown in FIG. 4, the thermoelectric device 30 of the present invention is inserted through the wall of a waste liquid discharge pipe 20 to be directly immersed in the high temperature waste liquid 21. In addition to increasing the contact with the high temperature waste liquid 21, it is less likely to be obstructed by the wall of the waste liquid discharge pipe 20, so that it has relatively better heat conduction performance and relatively suitability.

In the embodiment shown in FIG. 1 to FIG. 4, the thermoelectric device 30 of the present invention may further include an electrode cap 34 for covering a portion of the core rod electrode 32, extending out of the tubular electrode 31. The electrode cap 34 is made of a conductive material. This increases the convenience of the wiring between the thermoelectric device 30 and the application circuit. In the implementation, the electrode cap 34 may be formed of copper or copper alloy.

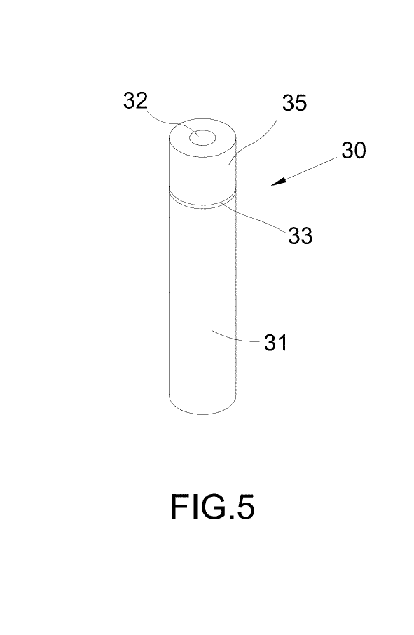

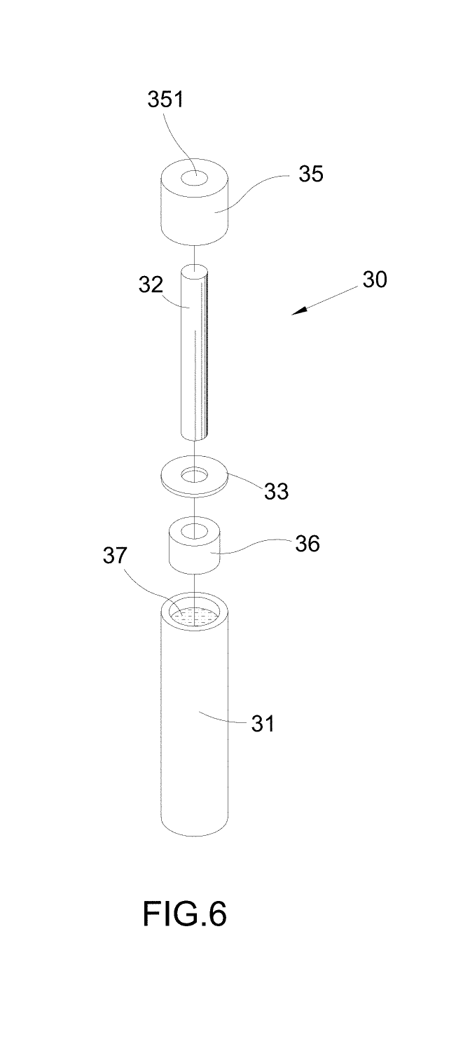

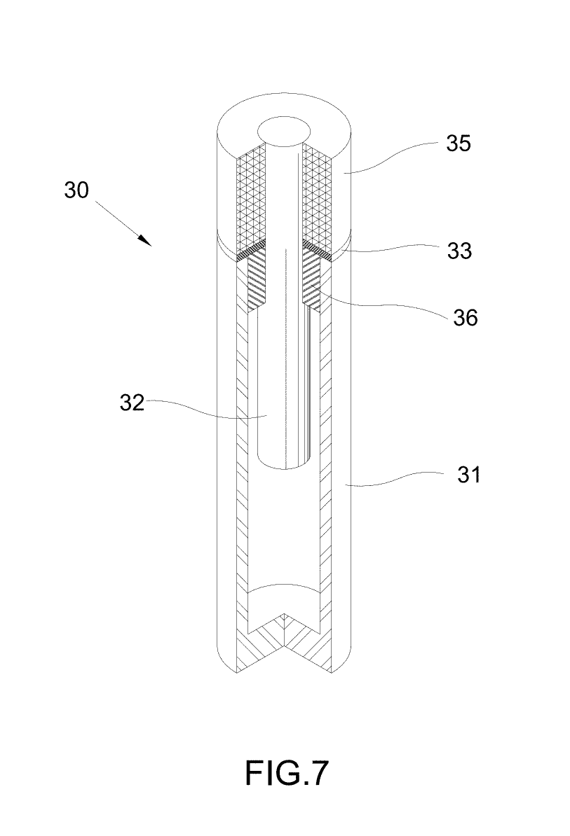

The thermoelectric device 30, as shown in FIG. 5 to FIG. 7, may further include an insulating sleeve 35 fitted on a portion of the core rod electrode 32, extending out of the tubular electrode 31. The insulating sleeve 35 is made of an insulating material. The insulating sleeve 35 has an electrode receiving hole 351 for exposing an end face of the core rod electrode 32 so as to increase the convenience and safety of the wiring between the thermoelectric device 30 and the application circuit. The insulating sleeve 35 may be formed of Teflon.

In the embodiment shown in FIG. 5 to FIG. 7, the thermoelectric device 30 may further include at least one support washer 36. The support washer 36 is fitted on a portion of the core rod electrode 32, inserted into the tubular electrode 31. The support washer 36 is made of an insulating material. The support washer 36 may be integrally formed with the insulating sleeve 35. Furthermore, the support washer 36 is provided with outer threads, and the tubular electrode 31 is provided with inner threads, so that the insulating sleeve 35 can be locked in the tubular electrode 31 to improve the stability and reliability of the thermoelectric device 30.

Of course, the thermoelectric device includes the electrode cap made of a conductive material to cover a portion of the core rod electrode, extending out of the tubular electrode; or the thermoelectric device includes the insulating sleeve made of an insulating material to cover a portion of the core rod electrode, extending out of the tubular electrode, and the insulating sleeve has the electrode receiving hole for exposing the end face of the core rod electrode; the thermoelectric device may further include at least one support washer made of an insulting material and fitted on a portion of the core rod electrode, inserted into the tubular electrode.

It is worth mentioning that the products of the thermoelectric device of the present invention have been completed. After a series of performance analysis and thermoelectric performance tests, the electrolyte containing nanometer metal powders (particles) have better thermal conductivity than pure water and seawater. In the actual redox reaction, the higher the ambient temperature, the higher the chemical reaction rate increases with the temperature, and the higher the electric energy. If the pressure decreases, the phase change point of the liquid-gas conversion is lower. That is, the lower the pressure in the tubular electrode, the better the thermal performance

In other words, the electrolyte of the thermoelectric device of the present invention is sealed inside the tubular electrode under a negative pressure environment. Preferably, the electrolyte is a nanofluid mixed with a metal nanopowder. Preferably, the electrolyte is a nanofluid mixed with a metal nanopowder and a surfactant. The surfactant may consist of a pre-set proportion of emulsifier and dispersant, thereby increasing the suspension stability of the nanofluid.

The electrolyte may be a nanofluid mixed with a metal nanopowder selected from one of titanium oxide, zinc oxide and alumina; a nanofluid mixed with a semiconductor nanopowder selected from one of lead telluride, bismuth telluride, cadmium telluride, and silicon germanium alloy; a nanofluid mixed with a graphene nanopowder; a nanofluid mixed with a metal nanopowder selected from one of titanium oxide, zinc oxide and alumina and a surfactant; a nanofluid mixed with a semiconductor nanopowder selected from one of lead telluride, bismuth telluride, cadmium telluride, and silicon germanium alloy and a surfactant; a nanofluid mixed with a graphene nanopowder and a surfactant. In a preferred embodiment, the electrolyte may be pure water mixed with 2 wt % of titanium oxide, 2 wt % of emulsifier, and 2 wt % of dispersant.

Compared to the prior art, the thermoelectric device of the present invention may be used for heat dissipation and able to output additional electric energy, and may use the structural design between the tubular electrode and the core rod electrode to provide a greater contact area with a heat source, and may be directly immersed in a heat source, so that it has relatively better heat conduction performance and relatively suitability. In particular, the overall structural design is beneficial for nanorizing a material used for redox, with a more positive and reliable means to enhance the thermal efficiency of the thermoelectric device.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A thermoelectric device, comprising a tubular electrode, a core rod electrode, and at least one plug;
the tubular electrode being made of a conductive material and having a tubular shape with a predetermined space therein, one end of the tubular electrode being formed with a filling opening for filling an electrolyte;
the core rod electrode being made of a conductive material and having a rod-like shape, the core rod electrode being inserted in the tubular electrode;
the plug being configured to separate the tubular electrode from the core rod electrode and to cover the filling opening of the tubular electrode, the plug being located between the tubular electrode and the core rod electrode;
the electrolyte being contact with the tubular electrode and the core rod electrode and sealed in the tubular electrode.

2. The thermoelectric device as claimed in claim 1, wherein a portion of the core rod electrode, extending out of the tubular electrode, is covered with an electrode cap made of a conductive material.

3. The thermoelectric device as claimed in claim 1, wherein a portion of the core rod electrode, extending out of the tubular electrode, is sleeved with an insulating sleeve made of an insulating material, and the insulating sleeve has an electrode receiving hole for exposing an end face of the core rod electrode.

4. The thermoelectric device as claimed in claim 1, wherein a portion of the core rod electrode, inserted into the tubular electrode, is sleeved with at least one support washer made of an insulating material.

5. The thermoelectric device as claimed in claim 1, wherein a portion of the core rod electrode, extending out of the tubular electrode, is covered with an electrode cap made of a conductive material; and another portion of the core rod electrode, inserted into the tubular electrode, is sleeved with at least one support washer made of an insulating material.

6. The thermoelectric device as claimed in claim 1, wherein a portion of the core rod electrode, extending out of the tubular electrode, is sleeved with an insulating sleeve made of an insulating material, the insulating sleeve has an electrode receiving hole for exposing an end face of the core rod electrode; and another portion of the core rod electrode, inserted into the tubular electrode, is sleeved with at least one support washer made of an insulating material.

7. The thermoelectric device as claimed in claim 1, wherein the electrolyte is a nanofluid mixed with a metal nanopowder.

8. The thermoelectric device as claimed in claim 1, wherein the electrolyte is a nanofluid mixed with a metal nanopowder and a surfactant.

9. The thermoelectric device as claimed in claim 1, wherein the electrolyte is a nanofluid mixed with a metal nanopowder selected from one of titanium oxide, zinc oxide and alumina.

10. The thermoelectric device as claimed in claim 1, wherein the electrolyte is a nanofluid mixed with a semiconductor nanopowder selected from one of lead telluride, bismuth telluride, cadmium telluride, and silicon germanium alloy.

11. The thermoelectric device as claimed in claim 1, wherein the electrolyte is a nanofluid mixed with a graphene nanopowder.

12. The thermoelectric device as claimed in claim 1, wherein the electrolyte is a nanofluid mixed with a metal nanopowder selected from one of titanium oxide, zinc oxide and alumina and a surfactant.

13. The thermoelectric device as claimed in claim 1, wherein the electrolyte is a nanofluid mixed with a semiconductor nanopowder selected from one of lead telluride, bismuth telluride, cadmium telluride, and silicon germanium alloy and a surfactant.

14. The thermoelectric device as claimed in claim 1, wherein the electrolyte is a nanofluid mixed with a graphene nanopowder and a surfactant.

15. The thermoelectric device as claimed in claim 1, wherein the electrolyte is pure water mixed with 2 wt % of titanium oxide, 2 wt % of emulsifier, and 2 wt % of dispersant.

16. The thermoelectric device as claimed in claim 1, wherein the tubular electrode is formed of aluminum or aluminum alloy.

17. The thermoelectric device as claimed in claim 1, wherein the core rod electrode is a carbon rod.

18. The thermoelectric device as claimed in claim 2, wherein the electrode cap is formed of copper or copper alloy.

19. The thermoelectric device as claimed in claim 3, wherein the insulating sleeve is formed of Teflon.

20. The thermoelectric device as claimed in claim 1, wherein the electrolyte is sealed inside the tubular electrode under a negative pressure environment.

21. The thermoelectric device as claimed in claim 6, wherein the support washer is integrally formed with the insulating sleeve.

22. The thermoelectric device as claimed in claim 6, wherein the support washer is provided with outer threads, and the tubular electrode is provided inner threads.
